(19) United States
(12) Patent Application Publication
(10) Pub. No.: US 2019/0129241 A1
(43) Pub. Date: May 2, 2019

(54) DISPLAY PANEL

(71) Applicant: HKC Corporation Limited, Shenzhen City, Guangdong (CN)

(72) Inventor: Beizhou HUANG, Shenzhen City, Guangdong (CN)

(21) Appl. No.: 15/743,034

(22) PCT Filed: Dec. 20, 2017
(86) PCT No.: PCT/CN2017/117341

§ 371 Date: Jan. 9, 2018

(30) Foreign Application Priority Data
Oct. 26, 2017 (CN) 201711010939.6

(51) Int. Cl. G02F 1/1335

(52) U.S. Cl. CPC G02F 1/133514; G02F 1/133512

(57) ABSTRACT

A display panel comprising a first substrate having a displaying area and a fan out area; a second substrate disposed opposite to the first substrate; a light shielding layer disposed on the first substrate and having a plurality of openings formed in a matrix manner and defining the displaying area and the fan out area of the first substrate; a color filter layer comprising a first color resistant layer disposed on the displaying area of the first substrate in a matrix manner and located on the portion of the plurality of openings of the light shielding layer, and a second color resistant layer disposed on the fan out area of the first substrate in a matrix manner and surrounding the light shielding layer; and a plurality of thin film transistors, disposed on one of the first substrate and the second substrate, located corresponding to the displaying area.

### FIELD OF THE INVENTION

The present disclosure relates to a display panel, and more particularly to a display panel having at least a color resistant marking region in the fan out area and a display apparatus using the display panel thereof.

### BACKGROUND OF THE INVENTION

With the development of flat panel display technology, the liquid crystal display (LCD) has gradually replaced traditional cathode ray tube display devices due to its advantages of lighter, thinner, lower driving voltage, low power consumption, no radiation and the like. The liquid crystal display apparatus basically includes a backlight and a liquid crystal display panel. The liquid crystal display panels widely used are generally provided with a color filter substrate, a thin film transistor and a liquid crystal layer interposed between the two substrates. And a sealing member is positioned between the two substrates in the peripheral region so as to bond the two substrates together, and the liquid crystal layer is hermetically sealed between the two substrates. Its working principle is applied the driving voltage on two glass substrates to control the rotation of the liquid crystal molecules of the liquid crystal layer, and then the light of the backlight module is refracted to generate a picture.

Since the demand for the resolution of the display apparatus becomes higher and higher, the aperture ratio of the corresponding pixel becomes smaller and smaller, therefore the width of the black matrix used to define the aperture ratio of the pixel also becomes smaller and smaller. According to the current trend is towards high resolution, it is very difficult to monitor the critical dimension, the so-called CD, of each color resistant on the display panel of the display apparatus in the manufacturing process.

Current state-of-the-art after first color resistant formed by, for example, the first photolithography there is no problem in the CD measurement, but no longer for the last color resistant forming due to the accuracy of equipment and the material used in the photolithography process. And therefore, after the last photolithography procedure is carried out, the overlapping occurs between color resistant of different colors, or the distances between the color resistant of different colors are too close, so that the effective boundary of the color resistant of the last color cannot be easily and clearly determined by means of the gray scale measurement or the like, and also the CD measurement can be carried out. Thus, there is a persistent desire to develop a new color resistant design to solve this problem.

### SUMMARY OF THE INVENTION

In order to solve the aforementioned technical problem, an object of the present invention is to provide a display panel, by virtue of the marking structure is designed within the color resistant layer on the fan out area of the display panel, the critical dimension of the different color resistant layers, such as the patterned red, green or blue color resistant layers can be rapidly recognized and easily measured without being influenced by the condition of the manufacturing process, and it can also retain the marking function of the color resistant layer on the fan out area.

The purpose of the present invention and the aforementioned technical problem to be solved can be realized by the following technical embodiments. According to the present invention, it provides a display panel, the display panel comprises a first substrate comprising a displaying area and a fan out area, a second substrate disposed opposite to the first substrate, a light shielding layer disposed on the first substrate and having a plurality of openings formed in a matrix manner and defining the displaying area and the fan out area of the first substrate. A color filter layer comprises a first color resistant layer disposed on the displaying area of the first substrate in a matrix manner and located on the portion of the plurality of openings of the light shielding layer, and a second color resistant layer disposed on the fan out area of the first substrate in a matrix manner and surrounding the light shielding layer. The second color resistant layer comprises a plurality of auxiliary colored resistant regions and at least a color resistant marking region interposed between the adjacent auxiliary colored resistant regions, and the color resistant marking region has a marking structure. A plurality of thin film transistors disposed on one of the first substrate and the second substrate, and located corresponding to the displaying area. Wherein the auxiliary colored resistant regions and the color resistant marking region are staggered disposed on a side of the first substrate.

The purpose of the present invention and the aforementioned technical problem to be solved can be further realized by the following technical embodiments.

In one embodiment of the present invention, the marking structure is a through hole and the through hole is disposed close to one side of the color resistant marking region.

In one embodiment of the present invention, a shape of a cross section of the through hole is a rectangle, a triangle, an elliptical arc or any combination of the rectangle, the triangle and the elliptical arc.

In one embodiment of the present invention, the axes of two adjacent through holes are posited in a line of planar and perpendicular to the axis of the through hole.

In one embodiment of the present invention, the two colors of the closest two auxiliary color resistant regions are different, and a color of the auxiliary color resistant region and a color of the adjacent color resistant marking region are different.

In one embodiment of the present invention, the marking structure is a color resistant block and the color resistant block is disposed on one side of the color resistant marking region.

In one embodiment of the present invention, an extending length of the color resistant marking region is longer than an extending length of the auxiliary color resistant region from the axis of the marking structure.

In one embodiment of the present invention, an extending length of each of the plurality of color resistant marking regions is the same, or the extending lengths of a portion of the plurality of color resistant marking regions are the same.

In one embodiment of the present invention, a portion of the plurality of color resistant marking regions includes a first extending length and another portion of the plurality of color resistant marking regions includes a second extending length, and at least one of a plurality of auxiliary color resistant regions includes a third extending length.

In one embodiment of the present invention, the values of the first extending length, the second extending length and the third extending length are different.

In one embodiment of the present invention, the values of the first extending length and the second extending length are greater than the value of the third extending length.

In one embodiment of the present invention, a color of one of the plurality of color resistant marking regions is different from a color of the closest color resistant marking region, and, a color of the auxiliary color resistant region and a color of the adjacent color resistant marking region are different.

Another object of the present invention is to provide a display panel comprising a first substrate comprising a displaying area and a fan out area, a second substrate disposed opposite to the first substrate, a light shielding layer disposed on the first substrate and having a plurality of openings formed in a matrix manner and defining the displaying area and the fan out area of the first substrate. A color filter layer comprises a first color resistant layer disposed on the displaying area of the first substrate in a matrix manner and located on the portion of the plurality of openings of the light shielding layer, and a second color resistant layer disposed on the fan out area of the first substrate in a matrix manner and surrounding the light shielding layer. The second color resistant layer comprises a plurality of auxiliary colored resistant regions and at least a color resistant marking region interposed between the adjacent auxiliary colored resistant regions, wherein the color resistant marking region having a marking structure. A plurality of thin film transistors disposed on one of the first substrate and the second substrate, and located corresponding to the displaying area. Wherein the auxiliary colored resistant regions and the color resistant marking region are staggered disposed on a side of the first substrate. Wherein the marking structure is a through hole and locating at close to one side of the color resistant marking region. Wherein a shape of a cross section of the through hole is a rectangle, a triangle, an elliptical arc or any combination of the rectangle, the triangle and the elliptical arc. Wherein the axes of two adjacent through holes are posited in a line of planar and perpendicular to the axis of the through hole, and two adjacent through holes are opposingly disposed on the two side of one of the plurality of auxiliary color resistant regions. Wherein a color of the auxiliary color resistant region and a color of the adjacent color resistant marking region are different, and two colors of the closest two auxiliary color resistant regions are different.

In the present invention, by virtue of the marking structure is designed within the color resistant layer on the fan out area of the display panel, the critical dimension of the different color resistant layers, such as the patterned red, green or blue color resistant layers can be rapidly recognized and easily measured.

Various other objects, advantages and features of the present invention will become readily apparent from the ensuing detailed description, and the novel features will be particularly pointed out in the appended claims.

### BRIEF DESCRIPTION OF FIGURES

The following detailed descriptions, given by way of example, and not intended to limit the present invention solely thereto, will be best be understood in conjunction with the accompanying figures:

FIGS. 1a and 1b are a top view and a cross sectional view respectively showing a portion of a first color resistant layer of an exemplary display panel according to one embodiment of the present invention;

FIGS. 2a and 2b are a top view and a cross sectional view respectively showing a portion of three color resistant layers of an exemplary display panel according to one embodiment of the present invention;

FIG. 3a is a schematic view showing a portion of an exemplary display panel according to one embodiment of the present invention;

FIG. 3b is a schematic view showing an enlarge portion of the fan out area of an exemplary display panel according to one embodiment of the present invention;

FIG. 4 is a schematic view showing a portion of the marking structure of the color resistant marking region of another exemplary display panel according to one embodiment of the present invention;

FIG. 5a is a schematic view showing a portion of the marking structure of the color resistant marking region of another exemplary display panel according to one embodiment of the present invention;

FIG. 5b is a schematic view showing a portion of the marking structure of the color resistant marking region of another exemplary display panel according to one embodiment of the present invention;

FIG. 6 is a schematic view showing a portion of an exemplary display panel according to one embodiment of the present invention; and

FIG. 7 is a schematic view showing a portion of another exemplary display panel according to one embodiment of the present invention.

### DETAILED DESCRIPTION OF THE EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

The drawings and description are to be regarded as illustrative in nature and not restrictive. Like reference numerals designate like elements throughout the specification. In addition, the size and thickness of each component shown in the drawings are arbitrarily shown for understanding and ease of description, but the present invention is not limited thereto.

In the drawings, the thickness of layers, films, panels, regions, etc., are exaggerated for clarity. In the drawings, for understanding and ease of description, the thicknesses of some layers and areas are exaggerated. It will be understood that, when an element such as a layer, film, region, or substrate is referred to as being “on” another element, it can be directly on the other element or intervening elements may also be present.

Furthermore, in the specification, “on” implies being positioned above or below a target element and does not imply being necessarily positioned on the top on the basis of a gravity direction.

For further explaining the technical means and efficacy of the present invention, a display panel including the embodiments, structures, features and effects thereof according to the present invention will be apparent from the following detailed description and accompanying drawings.

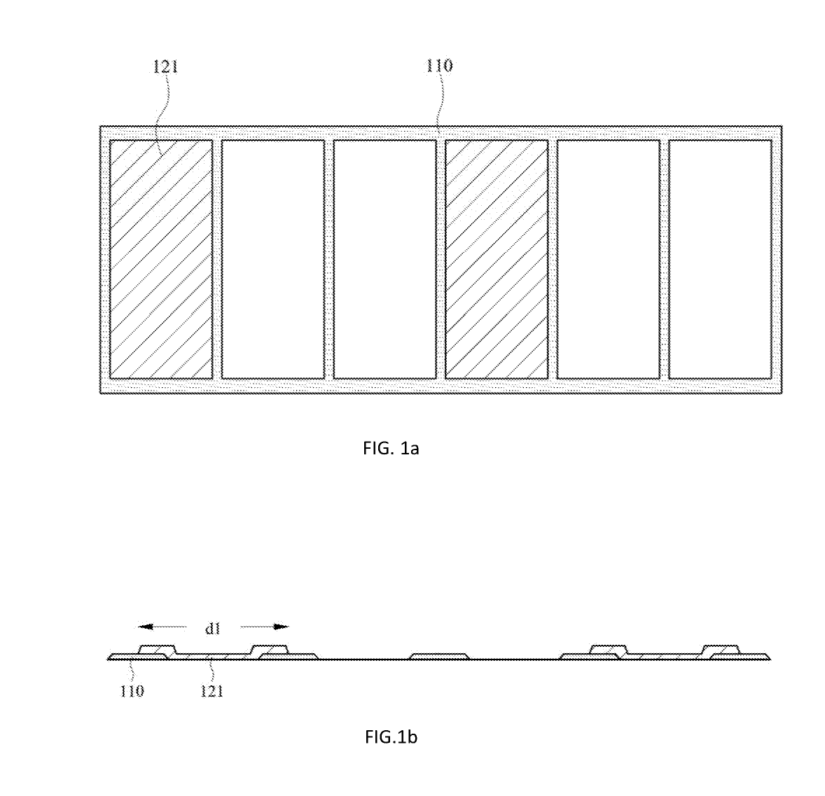

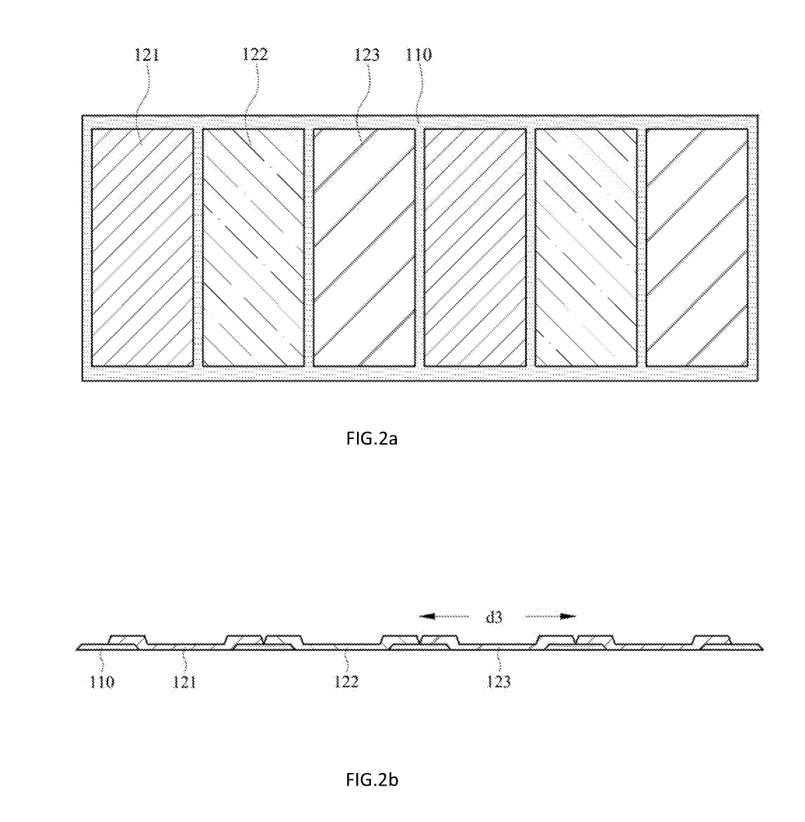

FIGS. 1a and 1b are a top view and a cross sectional view respectively showing a portion of a first color resistant layer of an exemplary display panel according to one embodiment of the present invention, and FIGS. 2a and 2b are top view and cross sectional view respectively showing a portion of three color resistant layers of an exemplary display panel according to one embodiment of the present invention. Referring to FIGS. 1a, 1b, 2a and 2b, a display panel according to one embodiment of the present invention comprises a first substrate (not shown in figure), a black matrix 110 disposed on the first substrate, a color filter layer comprising a red color resistant layer 121, a green color resistant layer 122 and a blue color resistant layer 123 disposed on the first substrate in a matrix manner respectively and located between the black matrix 110 correspondingly. In the manufacturing process, when a first color resistant layer such as the red resistant layer 121 is disposed on the first substrate, there is no other color resistant layer around the red resistant layer 121. Therefore, the size of dl of the patterned red resistant layer 121 can be rapidly recognized and easily measured, that is, the CD value. However, when the photolithography procedure or the printing process for the last color resistant layer such as the blue color resistant layer 123 is carried out on the first substrate, due to the patterned red color resistant layer 121 and the green color resistant layer 122 were already disposed around the blue color resistant layer 123, and because of the accuracy of equipment and the material used in the manufacturing process, the overlapping may be occur between the blue color resistant layer 123 and adjacent red color resistant layer 121 and the green color resistant layer 122, or the distances between different color resistant layers are too close, so that the effective boundary of the blue color resistant layer 123 cannot be easily and clearly determined by means of the gray scale measurement or the like, thus, the CD measurement of d3 of the blue color resistant layer 123 cannot be carried out.

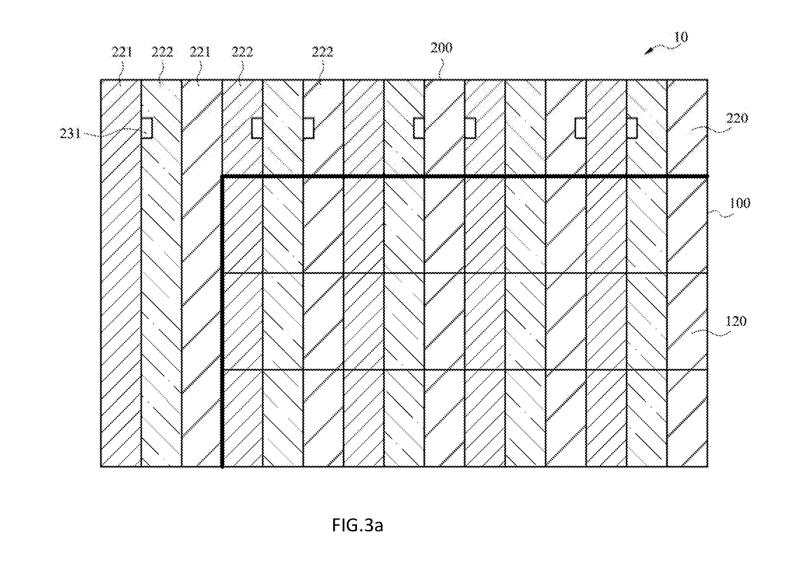

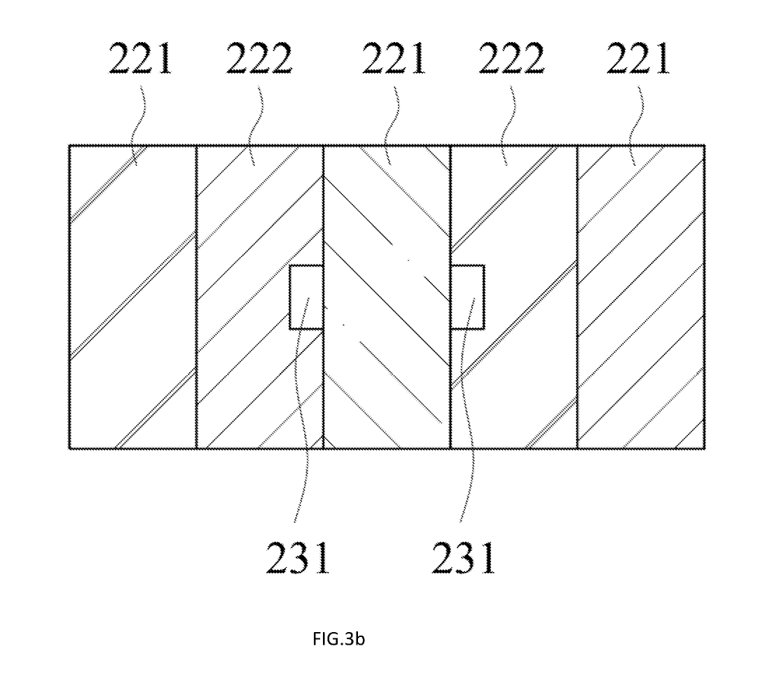

FIG. 3a is a schematic view showing a portion of an exemplary display panel according to one embodiment of the present invention, and FIG. 3b is a schematic view showing an enlarge portion of the fan out area of an exemplary display panel according to one embodiment of the present invention. Referring to FIGS. 3a and 3b, a display panel 10 according to one embodiment of the present invention comprises a first substrate (not shown in figure) having a displaying area 100 and a fan out area 200, a second substrate (not shown in figure) disposed opposite to the first substrate. A light shielding layer (not shown in figure) is disposed on the first substrate and having a plurality of openings formed in a matrix manner and defining the displaying area 100 and the fan out area 200 of the first substrate. A color filter layer comprises a first color resistant layer 120 disposed on the displaying area 100 of the first substrate in a matrix manner and located on the portion of the plurality of openings of the light shielding layer, and a second color resistant layer 220 disposed on the fan out area 200 of the first substrate in a matrix manner and surrounding the light shielding layer. The second color resistant layer 220 comprises a plurality of auxiliary colored resistant regions 221 and at least a color resistant marking region 222 interposed between the adjacent auxiliary colored resistant regions 221, wherein the color resistant marking region 222 having a marking structure 231. A plurality of thin film transistors (not shown in figure) are disposed on one of the first substrate and the second substrate, and located corresponding to the displaying area. Wherein the marking structure 231 is a through hole.

In one embodiment of the present invention, a side of the first substrate is disposed with an auxiliary color resistant region 221 and a color resistant marking region 222, and the auxiliary colored resistant region 221 and the color resistant marking region are staggered. In the embodiment of the present application, the auxiliary color resistant region 221 and the color resistant marking region 222 are illustrated as being disposed above the first substrate for example, but not limiting thereto possible variety of the layout on the substrate. The auxiliary color resistant region 221 and the color resistant marking region 222 may also be disposed on the left and right peripheries of the first substrate or the other side of the first substrate.

In one embodiment of the present invention, the through hole 231 is disposed on a side of the color resistant marking region 222.

In one embodiment of the present invention, the cross section of the through hole 231 is in a shape of the rectangle.

In one embodiment of the present invention, two adjacent through holes 231 are opposingly disposed on the two sides of one of the plurality of auxiliary color resistant regions, and the axes of two adjacent through holes 231 are posited in a line of planar and perpendicular to the axis of the through hole 231 as showing in FIG. 3b.

In one embodiment of the present invention, the two colors of the closest two auxiliary color resistant regions 221 are different, and a color of the auxiliary color resistant region 221 and a color of the adjacent color resistant marking region 222 are different.

In one embodiment of the present invention, by utilizing the through holes 231 opposingly disposed on the two sides of one of the plurality of auxiliary color resistant regions 221, the CD measuring instrument can determine and precisely measure the CD value of the auxiliary color resistant region 221 sandwiched between the color resistant marking regions 222. In addition, because of the through hole is designed within the color resistant marking region 222, the layout of a second color resistant layer 220 can't be drastically changed, and the function of the second color resistant layer 220 can also be retained.

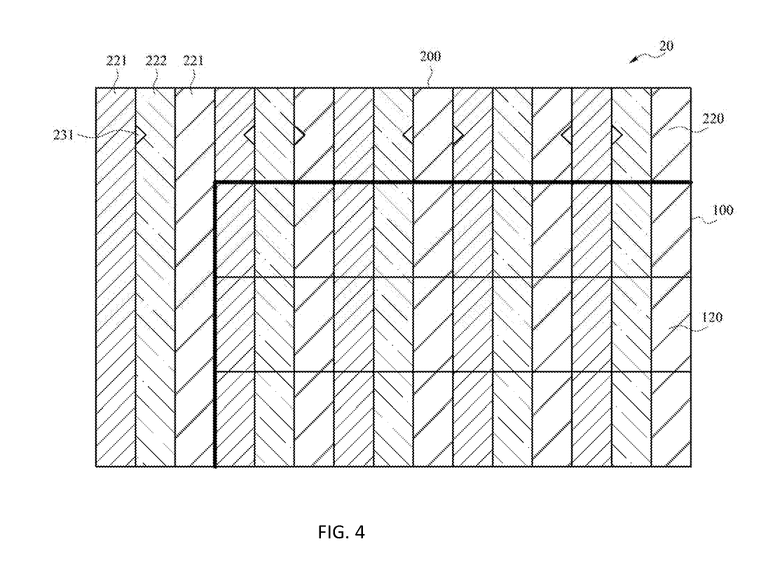

FIG. 4 is a schematic view showing a portion of the marking structure of the color resistant marking region of another exemplary display panel according to one embodiment of the present invention. Referring to FIG. 4, a display panel 20 according to one embodiment of the present invention and comparing with the aforementioned display panel 10, the marking structure of the color resistant marking region of the display panel 20 is a through hole 231 and its cross section is in a shape of triangle. On the basis of the rectangular shaped through holes, in particular, within the certain dimension of the length and width of the rectangular shape, the triangular shaped through holes can make the cross sectional area of the through holes smaller and thereby the layout influence on the color resistant marking region can be reduced to be smaller.

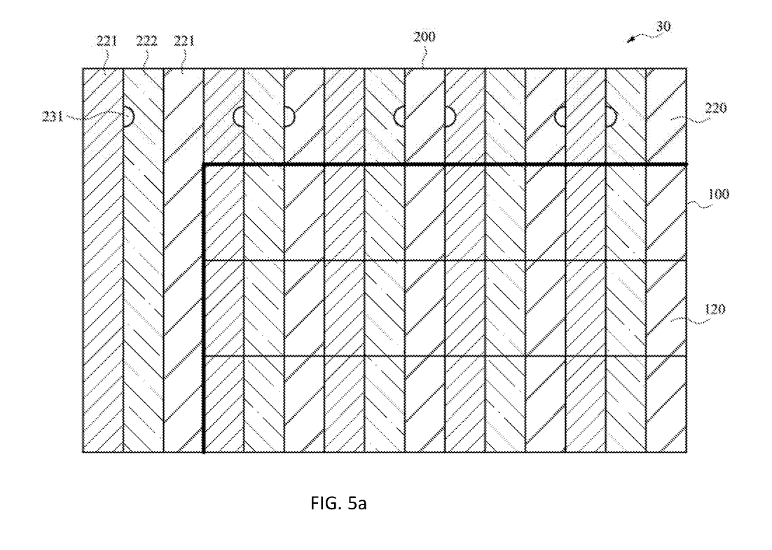

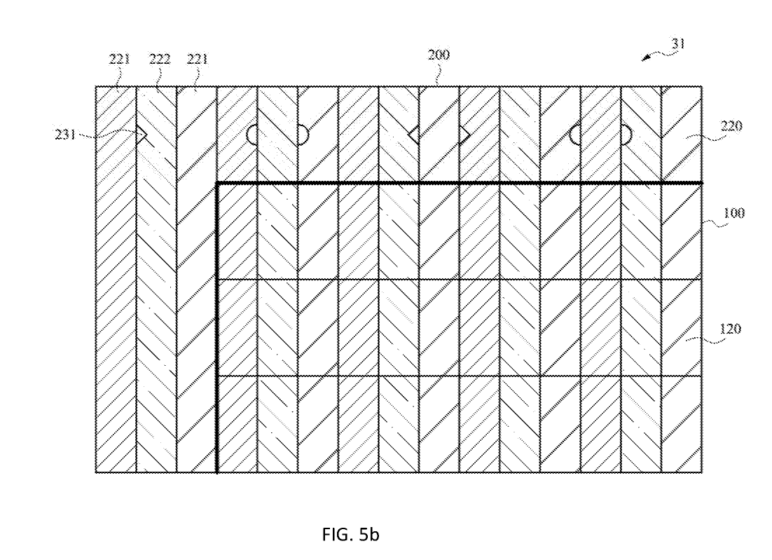

FIG. 5a is a schematic view showing a portion of the marking structure of the color resistant marking region of another exemplary display panel according to one embodiment of the present invention. Referring to FIG. 5a, a display panel 30 according to one embodiment of the present invention and comparing with the aforementioned display panels 10 and 20, the marking structure of the color resistant marking region of the display panel 30 is a through hole 231 and its cross section is in a shape of an elliptical arc. Comparing with the rectangular shaped through holes, because of the special shape of the elliptical arc such as long axis and short axis, corresponding to the length and width of the rectangular shape, so that the display panel design with the elliptical arc shaped through holes the precision of the CD value measured by the measuring instrument can be ensured. Moreover, the elliptical arc shaped through hole is benefited from minify the cross sectional area in a certain range. In general, the shape of the semicircular arc is a special case of an elliptical arc shape, in the present embodiment, the shape of the semicircular arc is also covered by the shape of the elliptical arc.

FIG. 5b is a schematic view showing a portion of the marking structure of the color resistant marking region of another exemplary display panel according to one embodiment of the present invention. Referring to FIGS. 3a to 5a, in some embodiments of the present invention, a plurality of through holes 231 in the color resistant marking region 222 of a display panel 31 may composited of a combination of at least two of a rectangular shape, a triangular shape, an elliptical arc shape, or other geometric shapes. In the present embodiment, a combination of a triangular shape and an elliptical arc shape is exemplified. However, the color resistant marking region 222 may also be a rectangular shape and a triangular shape, a combination of a rectangular shape and an elliptical arc shape, or a combination of three or more shapes, but not limited thereto.

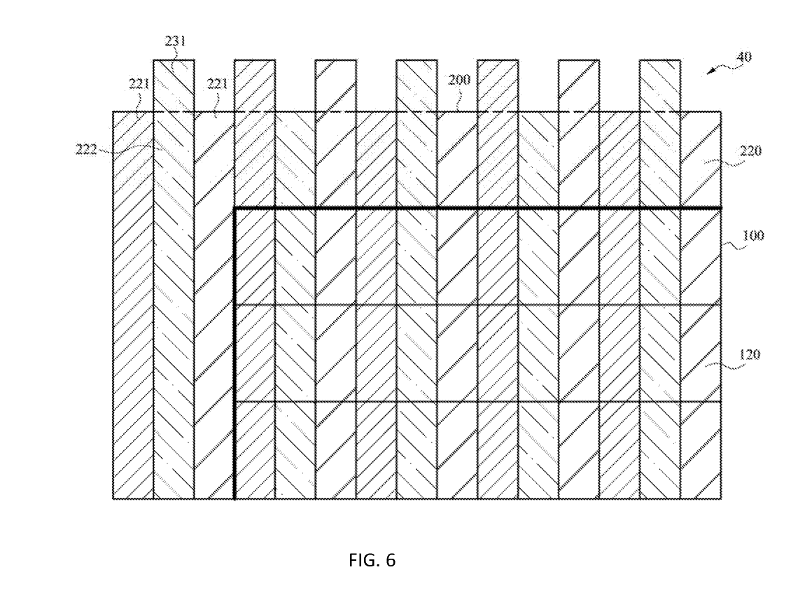

FIG. 6 is a schematic view showing a portion of an exemplary display panel according to one embodiment of the present invention. Referring to FIG. 6, a display panel 40 according to one embodiment of the present invention comprises a first substrate (not shown in figure) having a displaying area 100 and a fan out area 200, a second substrate (not shown in figure) disposed opposite to the first substrate. A light shielding layer (not shown in figure) is disposed on the first substrate and having a plurality of openings formed in a matrix manner and defining the displaying area 100 and the fan out area 200 of the first substrate. A color filter layer comprises a first color resistant layer 120 disposed on the displaying area 100 of the first substrate in a matrix manner and located on the portion of the plurality of openings of the light shielding layer, and a second color resistant layer 220 disposed on the fan out area 200 of the first substrate in a matrix manner and surrounding the light shielding layer. The second color resistant layer 220 comprises a plurality of auxiliary colored resistant regions 221 and at least a color resistant marking region 222 interposed between the adjacent auxiliary colored resistant regions 221, wherein the color resistant marking region 222 having a marking structure 231. A plurality of thin film transistors (not shown in figure) is disposed on one of the first substrate and the second substrate, and located corresponding to the displaying area. Wherein the marking structure 231 is a color resistant block 231, and the color resistant block 231 is disposed on one side of the color resistant marking region 222.

In one embodiment of the present invention, an extending length of the color resistant marking region 222 is longer than an extending length of the auxiliary color resistant region 221 from the axis of the marking structure 231.

In one embodiment of the present invention, the two colors of the closest two auxiliary color resistant regions 221 are different, and a color of the auxiliary color resistant region 221 and a color of the adjacent color resistant marking region 222 are different.

In one embodiment of the present invention, because of the design of the auxiliary color resistant region 221 and the color resistant marking region 222 are staggered, and the color resistant marking region 222 further comprises a protruding portion such as the color resistant block 231 without the other color resistant layer surrounding the protruding portion, so that the dimension of the patterned color resistant layer, that is, the CD value can be rapidly recognized and easily measured by the measuring instrument.

The display panel 40 of the aforementioned embodiment, each of the plurality of color resistant marking regions 222 has the same length and substantially end at the same distance to the edge of the substrate, but not limited thereto, the plurality of color resistant marking regions 222 have the same length in part, that is, the plurality of color resistant marking regions 222 have multiple lengths.

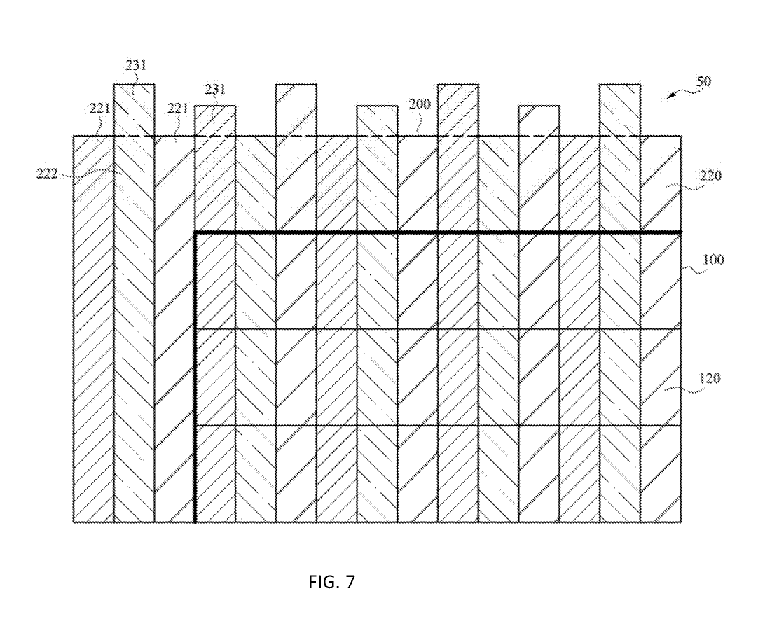

FIG. 7 is a schematic view showing a portion of another exemplary display panel according to one embodiment of the present invention. Referring to FIG. 7, a display panel 50 according to one embodiment of the present invention comprises a plurality of color resistant marking regions 222 having a plurality of lengths. Taking the two heights as an example, by virtue of the design of the color resistant block 231, a portion of the plurality of color resistant marking regions 222 includes a first extending length and another portion of the plurality of color resistant marking regions 222 includes a second extending length, and the first extending length is different from the second extending length. Wherein at least one of the plurality of auxiliary color resistant regions includes a third extending length, and the values of the first extending length, the second extending length and the third extending length are different. Moreover, the values of the first extending length and the second extending length are greater than the value of the third extending length.

Referring to FIGS. 3a to 7, a display panel (10, 20, 30, 31, 40, 50) according to one embodiment of the present invention comprises a first substrate (not shown in figure) and a second substrate (not shown in figure) opposingly disposed, a plurality of thin film transistors (not shown in figure) disposed on the first substrate or the second substrate, a color filter layer disposed on the first substrate and locating corresponding to the plurality of thin film transistors. A light shielding layer is disposed on the first substrate and has a plurality of openings formed in a matrix manner and located between the plurality of thin film transistors and the color filter layer and corresponding to the color filter layer, for defining the displaying area 100 and the fan out area 200 of the display panel. The color filter layer comprises a first color resistant layer 120 disposed on the displaying area 100 in a matrix manner and a second color resistant layer 220 disposed on the fan out area 200 in a matrix manner.

In one embodiment of the present invention, a plurality of auxiliary colored resistant regions 221 and a plurality of color resistant marking regions 222 having a plurality of marking structures 231 are design correspondingly according to the requirement of the display panel. The plurality of auxiliary colored resistant regions 221 and the plurality of color resistant marking regions 222 are dummy color resistant layers disposed on the fan out area. In the above mentioned embodiments, each of the plurality of color resistant marking regions 222 is disposed between the two adjacent auxiliary colored resistant regions 221, on the contrary, the plurality of auxiliary colored resistant regions 221 may be sandwiched between the two adjacent color resistant marking regions 222.

In one embodiment of the present invention, the display panel (10, 20, 30, 31, 40, 50) may be, for example, a liquid crystal display panel, but not limited thereto, also may be a OLED display panel, a W-OLED display panel, a QLED display panel, a plasma display panel, a curved display panel, or other type of display panel.

In the present invention, by virtue of the marking structure 231 is designed within the second color resistant layer 220 on the fan out area of the display panel, the critical dimension of the different color resistant layers, that is, the width of each of the patterned red, green and blue color resistant layers can be rapidly recognized and easily measured without being influenced by the condition of the manufacturing process, and it can also retain the marking function of the second color resistant layer on the fan out area.

In addition, in the specification, unless explicitly described to the contrary, the word “comprise” and variations such as “comprises” or “comprising” will be understood to imply the inclusion of stated elements but not the exclusion of any other elements.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A display panel, comprising:
a first substrate, comprising a displaying area and a fan out area;
a second substrate, disposed opposite to the first substrate;
a light shielding layer, disposed on the first substrate and having a plurality of openings formed in a matrix manner, and defining the displaying area and the fan out area of the first substrate;
a color filter layer, comprising:
a first color resistant layer, disposed on the displaying area of the first substrate in a matrix manner and located on the portion of the plurality of openings of the light shielding layer;
a second color resistant layer, disposed on the fan out area of the first substrate in a matrix manner and surrounding the light shielding layer, and comprising a plurality of auxiliary colored resistant regions and at least a color resistant marking region interposed between the adjacent auxiliary colored resistant regions, wherein the color resistant marking region having a marking structure; and
a plurality of thin film transistors, disposed on one of the first substrate and the second substrate, located corresponding to the displaying area;
wherein the auxiliary colored resistant regions and the color resistant marking region are staggered disposed on a side of the first substrate.

2. The display panel according to claim 1, wherein the marking structure is a through hole.

3. The display panel according to claim 2, wherein the through hole is disposed close to one side of the color resistant marking region.

4. The display panel according to claim 3, wherein a shape of a cross section of the through hole is a rectangle, a triangle, an elliptical arc or any combination of the rectangle, the triangle and the elliptical arc.

5. The display panel according to claim 3, wherein the axes of two adjacent through holes are posited in a line of planar and perpendicular to the axis of the through hole.

6. The display panel according to claim 5, wherein two adjacent through holes are opposingly disposed on the two side of one of the plurality of auxiliary color resistant regions.

7. The display panel according to claim 3, wherein two colors of the closest two auxiliary color resistant regions are different.

8. The display panel according to claim 7, wherein a color of the auxiliary color resistant region and a color of the adjacent color resistant marking region are different.

9. The display panel according to claim 1, wherein the marking structure is a color resistant block.

10. The display panel according to claim 9, wherein the color resistant block is disposed on one side of the color resistant marking region.

11. The display panel according to claim 10, wherein an extending length of the color resistant marking region is longer than an extending length of the auxiliary color resistant region from the axis of the marking structure.

12. The display panel according to claim 11, wherein the extending length of each of the plurality of color resistant marking regions is the same.

13. The display panel according to claim 11, wherein the extending lengths of a portion of the plurality of color resistant marking regions are the same.

14. The display panel according to claim 13, wherein a portion of the plurality of color resistant marking regions includes a first extending length and another portion of the plurality of color resistant marking regions includes a second extending length.

15. The display panel according to claim 14, wherein at least one of the plurality of auxiliary color resistant regions includes a third extending length.

16. The display panel according to claim 15, wherein values of the first extending length, the second extending length and the third extending length are different.

17. The display panel according to claim 15, wherein the values of the first extending length and the second extending length are greater than the value of the third extending length.

18. The display panel according to claim 10, wherein a color of one of the plurality of color resistant marking regions is different from a color of the closest color resistant marking region.

19. The display panel according to claim 18, wherein a color of the auxiliary color resistant region and a color of the adjacent color resistant marking region are different.

20. A display panel, comprising:
a first substrate, comprising a displaying area and a fan out area;
a second substrate, disposed opposite to the first substrate;
a light shielding layer, disposed on the first substrate and having a plurality of openings formed in a matrix manner and defining the displaying area and the fan out area of the first substrate;
a color filter layer, comprising:
a first color resistant layer, disposed on the displaying area of the first substrate in a matrix manner and located on the portion of the plurality of openings of the light shielding layer;
a second color resistant layer, disposed on the fan out area of the first substrate in a matrix manner and surrounding the light shielding layer, comprising a plurality of auxiliary colored resistant regions and at least a color resistant marking region interposed between the adjacent auxiliary colored resistant regions, wherein the color resistant marking region having a marking structure; and
a plurality of thin film transistors, disposed on one of the first substrate and the second substrate, located corresponding to the displaying area;
wherein the auxiliary colored resistant regions and the color resistant marking region are staggered disposed on a side of the first substrate;
wherein the marking structure is a through hole and locating at close to one side of the color resistant marking region;
wherein a shape of a cross section of the through hole is a rectangle, a triangle, an elliptical arc or any combination of the rectangle, the triangle and the elliptical arc;
wherein the axes of two adjacent through holes are posited in a line of planar and perpendicular to the axis of the through hole, and two adjacent through holes are opposingly disposed on the two side of one of the plurality of auxiliary color resistant regions;
wherein a color of the auxiliary color resistant region and a color of the adjacent color resistant marking region are different, and two colors of the closest two auxiliary color resistant regions are different.
